(19) United States
(12) Patent Application Publication
(10) Pub. No.: US 2005/0131953 A1
(43) Pub. Date: Jun. 16, 2005

(54) Information providing method, information management device and program

(75) Inventors: Hirokazu Sugiyama, Tokyo (JP); Tsuyoshi Suzuki, Tokyo (JP); Toshihiko Oda, Tokyo (JP); Yoshiaki Imajima, Tokyo (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/046,869

(22) Filed: Feb. 1, 2005

Related U.S. Application Data
(63) Continuation of application No. PCT/JP03/01577, filed on Feb. 14, 2003.

(51) Int. Cl. G06F 7/00

(52) U.S. Cl. 707/104.1

(57) ABSTRACT

The present invention enables a person to specify the users of terminal devices that the person desires to access common information, as members of a group, enables the users of the terminal devices to specify information to be accessed by the members of the group as information to be shared, among information provided by an information providing system via a communication network, and presents the information to be shared by the users of the terminal devices that constitute a group and enables the users to arbitrarily access the information to be shared.

### CROSS REFERENCE TO RELATED APPLICATION

This application is a continuation of an International Application No. PCT/JP03/01577, which was filed on Feb. 14, 2003.

### BACKGROUND OF THE INVENTION

1. Field of the Invention

The present invention relates to a technology for enabling the user of a terminal device to access information (content) provided by an information providing system via a communication network.

2. Description of the Related Art

Recently, communication networks have rapidly developed into an information infrastructure. Thus, currently, communication networks are used to provide a variety of services. For example, on the Internet which is a global information infrastructure for connecting a variety of communication networks, a lot of sites for providing a variety of services, such as the origination (distribution) of information, the sales of goods and the like, are accessible. An information providing system is built to provide services for originating information. Hereinafter, information to be originated is called “content”.

Content to be originated using a communication network can be shared by the users of terminal devices connected or that can be connected to a communication network. The sharing can be realized by a person desiring to share content conveying access information (Uniform Resource Locator (URL), etc.) used to access the content to a partner. However, in such a method, the person desiring to share the content must convey the access information to the partner. The partner must access the content according to the access information. In other words, both a person conveying access information and users accessing content must perform troublesome operations. Therefore, Japanese Patent Application No. 2002-268986 discloses such a method providing a means of easily sharing content.

FIG. 1 explains the conventional information providing method disclosed in Japanese Patent Application No. 2002-268986. The conventional method is described below with reference to FIG. 1. In FIG. 1, reference numerals 11, 12 and 13 represent content provider (CP) for providing content, a management server for managing services for distributing content provided by the CP 11 and a user company concluding an agreement for using the CP 11 and management server 12, respectively. The CP 11 and management server 12 are connected to a public network, such as the Internet. Terminal devices used by employees of a user company a connected to a telephone network, a cellular phone network or the like.

As to employees A through C of the user company 13 (i.e. customer of CP), it is assumed that employee A has an identification (ID) for using the CP 11, and employees B and C do not have IDs. The method in the case where employee A desires to share content provided by the CP 11 with employees B and C is described below.

Employee A accesses the CP 11 and browses the content provided by the CP 11 (sequence (1) ).If employee A desires to share the browsed content, employee A accesses the management server 12, and specifies the content and partners who share the content (in this case, employees B and C)(sequence (2)). The content can be specified, for example, by inputting its URL, and the partners can be specified, for example, by inputting their addresses or phone numbers.

When the content and sharing partners are specified and the sharing of the content is requested, the management server 12 downloads the content from the CP 11 (sequence (3)). The management server 12 distributes the downloaded content to the terminal devices of the specified partners (sequence (4)).

If the content downloaded by the management server 12 is charged, the CP 11 requests the management server 12 to report the price of the distribution. When the request is received, the management server 12 charges employee A the price requesting for the sharing of the content, and notifies the CP 11 of the result of the process (sequence (5)). If employee A uses a cellular phone as his/her terminal device, the price is charged to the carrier.

As described above, in the conventional information providing method, by making the management server 12 distribute content provided by the CP 11, the content provided by the CP 11 can easily be shared even by an employee unable to access the CP11. However, since such sharing by distribution is conducted unconditionally, the price is reported regardless of the content if the content is charged, which is a problem.

In this case, a partner desiring to repeatedly browse the content must manage the distributed content by himself/herself. Therefore, the management of content is troublesome, which is another problem.

Even if a specific person desires to share content (information), sometimes his/her partner considers the content unnecessary or may have already browsed the content. In such cases, if the content is double charged, and the price of the sharing the content is wasted. Therefore, in the sharing of content, it is also important to avoid such over charging. Patent Reference 1: Japanese Patent Application No. 2002-268986

### SUMMARY OF THE INVENTION

It is an object of the present invention to provide a technology for avoiding the charging when sharing charged content (information) is unnecessary for a partner and also to facilitate the easy sharing of content.

The first aspect of an information providing method of the present invention is a method for an information management device enabling the terminal device of a user belonging to a group and desiring access to the same information as other members of the group, to access information provided by an information providing system via a communication network, comprising, receiving a notice for specifying information accessed by a user of a terminal device belonging to a group of information provided by the information providing system as information to be shared by the group and information for accessing the information to be shared, from a user of a terminal device, and transmitting information for accessing the information to be shared to a user of a terminal device belonging to the group in response to a request for information for accessing the information to be shared from a user of a terminal device belonging to the group.

The second aspect of an information providing method of the present invention is a method for an information providing system providing information via a communication network (information network). The information providing method comprises transmitting the information to be provided to the terminal device together with a picture or display indicating a command to specify the information as information to be shared by the users of terminal devices belonging to the group and desiring to access the same information.

In the first aspect, it is preferable for the information management device to transmit information to be shared to the user of a terminal device when receiving notice of having selected information of an access to information to be shared from the user of a terminal device. If charged information provided by the information providing system is specified as information to be shared, it is preferable for the information management device to manage collection data for the information providing system to collect a price caused by the user of a terminal device selecting the information to be shared.

It is also preferable for the information management device to authenticate the user of a terminal device that accesses the information management device via its terminal device and to specify a group to which the user belongs, based on the result of the authentication. Furthermore, it is preferable for the information management device to receive data for the sharing of the information to be shared when receiving information about an access of the information to be shared and to transmit the information about an access of the information to be shared to each user of the terminal device that belongs to the group, based on the data to be shared.

Each of the first through third aspects of information management devices of the present invention is presumed to enable a user of a terminal device to access information provided by an information providing system via a communication network and comprises the following units.

The first aspect of an information management device comprises a group specification unit for enabling a person to specify users devices of terminal that the person desires to access the same information as members belonging to a group, an information acquisition unit for obtaining at least information related to information that the user of a terminal device specifies as information to be shared by the group, among information provided by an information providing system and a shared information presentation unit for presenting the information to be shared by the group to which the user belongs, to the users of terminal devices, using the related information.

The second aspect of an information management device further comprises in addition to the configuration of the first aspect a transmission control unit for enabling the terminal device to transmit information to be shared when the user of a terminal device selects the information to be shared and presented by the shared information presentation unit.

It is preferable for the transmission control unit in the second aspect to manage collection data for the information providing system to charge corresponding to the user of a terminal device selecting the information to be shared which is provided for pay by the information providing system.

The third aspect of an information management device further comprises in addition to the configuration in the first or second aspect an authentication unit for authenticating each user of the terminal device that accesses, and the shared information presentation unit specifies a group to which the user of a terminal device belongs, based on the authentication result of the authentication unit and presents information to be shared specified by the group.

In any of the first through third aspects, it is preferable for the information acquisition unit to enable the user of the terminal to input data related to the sharing of information to be shared, and also for the shared information presentation unit to present information to be shared, based on the data input by the user of the terminal device that specified the information to be shared.

The program of the present invention is executed by an information management device for enabling the users of terminal devices to access information provided by an information providing system via a communication network. The program comprises a function to enable a person to specify users of terminal devices that the person desires to access the same information, as members belonging to a group, a function to obtain at least information related to information that the user of a terminal device specifies as information to be shared by a group, among information provided the information providing system and a function to present information to be shared by the group to which the user of a terminal device belongs, to the users of terminal devices, using related information.

The present invention enables a person to specify users of terminal devices that the person desires to access the same information, as members belonging to a group, obtains at least information related to the information that the user of a terminal device specifies as information to be shared by a group, among information provided the information providing system, and presents the information to be shared by the group to the users belonging the group, using the related information.

By presenting information to be shared, each member user can arbitrarily access the information to be shared. The user can access it easily, too. Thus, content can easily be shared while avoiding charging accompanied by the sharing of unnecessary charged content from each shared partner.

When a user of a terminal device selects the presented information to be shared and information is transmitted to the terminal device, the access to the information can be more easily.

### BRIEF DESCRIPTION OF THE DRAWINGS

FIG. 1 explains how to provide information conventionally;

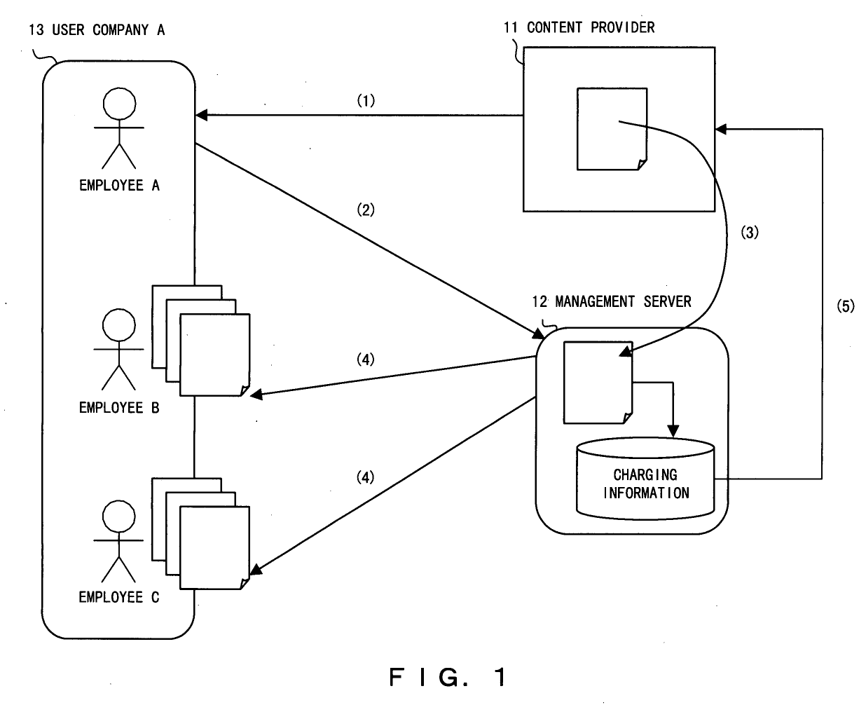

FIG. 2 shows the configuration of a network system provided with the information (content) management device of the present invention;

FIG. 3 explains a service provided by the content management device;

FIG. 4 shows the sequence of data registration performed when an agreement is concluded between a CP and the content management device;

FIG. 5 shows the sequence of data registration performed when an agreement is concluded between a user company and a CP;

FIG. 6 shows the sequence of data registration performed when an agreement is concluded between a user company and the content management device;

FIG. 7 shows the sequence in the case where the employees of the user company share content provided by a CP;

FIG. 8 shows the sequence in the case where an employee of the user company accesses content shared by a the content management device;

FIG. 9 shows the sequence in the case where the content management device provides a CP with charging information;

FIG. 10 is a flowchart showing the processes of the terminal device in the case where a user requests the sharing of content;

FIG. 11 is a flowchart showing the processes of the CP in the case where a user requests the sharing of content;

FIG. 12 is a flowchart showing the processes of the content management device in the case where a user requests the sharing of content;

FIG. 13 is a flowchart showing the processes of a terminal device in the case where a user accesses shared content;

FIG. 14 is a flowchart showing the processes of the content management device in the case where a user accesses shared content;

FIG. 15 is a flowchart showing a list transmitting process;

FIG. 16 is a flowchart showing the process of a CP in the case where a user accesses shared content;

FIG. 17 shows a content display screen;

FIG. 18 shows a setting screen for sharing;

FIG. 19 shows a content list screen;

FIG. 20 shows the structure of content information to which a CPID is attached;

FIG. 21 shows the structure of discount information registered on a discount information database (DB) managed by both the CP and the content management device;

FIG. 22 shows the structure of authentication information registered on an authentication database (DB) managed by the content management device;

FIG. 23 shows the structure of access information registered on a content management database (DB) 58 b;

FIG. 24 shows the structure of authentication information registered on authentication database (DB) managed by the CP in order to share content;

FIG. 25 shows the structure of authentication information transmitted when authentication is requested;

FIG. 26 shows information transmitted by a terminal device to the content management device when the sharing of content is requested;

FIG. 27 the structure of content sharing information recorded on the content management DB managed by the content management device;

FIG. 28 shows the structure of charging information registered on a charge management DB managed by the content management device; and

FIG. 29 storage media on which a program is recorded.

### DESCRIPTION OF THE PREFERRED EMBODIMENTS

The preferred embodiments of the present invention are described below with reference to the drawings.

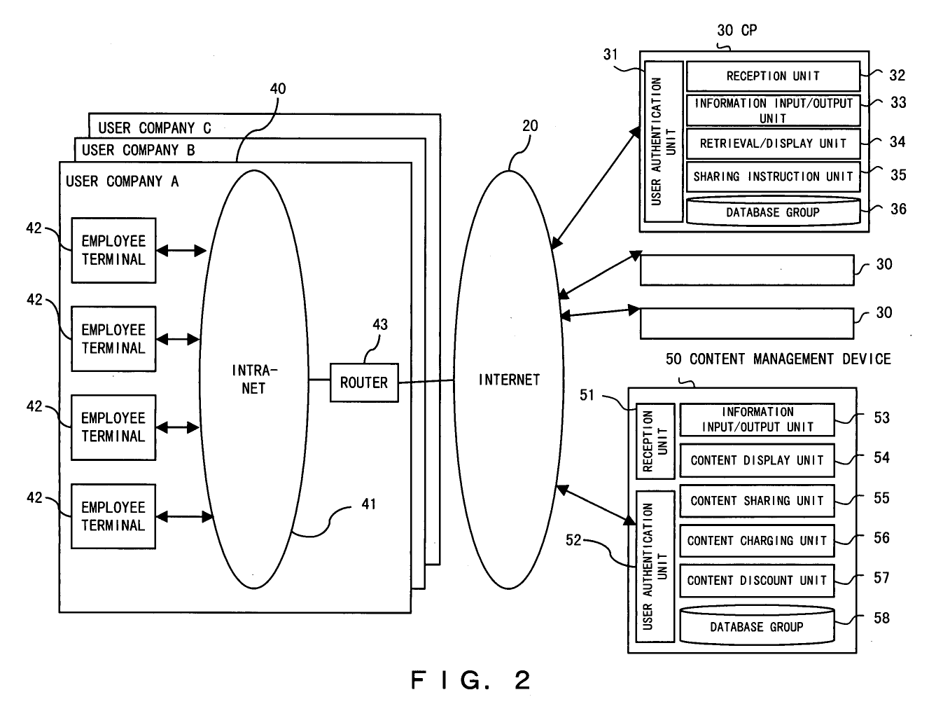

FIG. 2 shows the configuration of a network system provided with the information (content) management device of the present invention.

Its content management device 50 provides the service of enabling the employees of a user company 40 to share content provided as a service by a content provider (CP) 30. As shown by FIG. 2, the network system comprises the management device 50, a plurality of CPs 30 and a plurality of user companies 40 which are connected to the Internet 20.

In a user company 40-A, which is one of the user companies 40, an intra-net 41 is implemented, and the terminal device 42 of each employee is connected to the intra-net 41. The intra-net 41 is connected to the Internet 20 via a router 43. Thus, each terminal device 42 is connected to the Internet 20 via the intra-net 41 and router 43. For the terminal device 42, a personal computer (PC), a personal digital assistant (PDA), a cellular phone and the like are used.

The CP 30, for example, provides persons, who made contracts, with charged content. The CP 30 issues IDs/passwords (PW) for using services to the employees of the user company 40, according to an agreement with the user company 40 or each employee. The ID/PW issued according to the agreement with the user company 40 is sent, for example, from the user company 40 to each employee. In this example, the following description is made assuming that the ID/PW possessed by each employee of the user company 40 is issued according to an agreement concluded with the user company 40.

Information needed by each employee varies depending on his/her role or job function. As such, even if the user company 40 concludes an agreement after determining the scope (group) of employees allowed to access a CP 30, content provided by the CP 30 are not always useful to the employees within the scope exclusively. In other words, the content may also be useful to employees that are desired access to (not allowed) the CP 30. It is preferable for such content to be shared with the employees that are not allowed to access the CP 30. The content management device 50 provides the service of enabling such content to be shared between the employees that are allowed to access the CP 30 and the employees that are not allowed to access the CP 30.

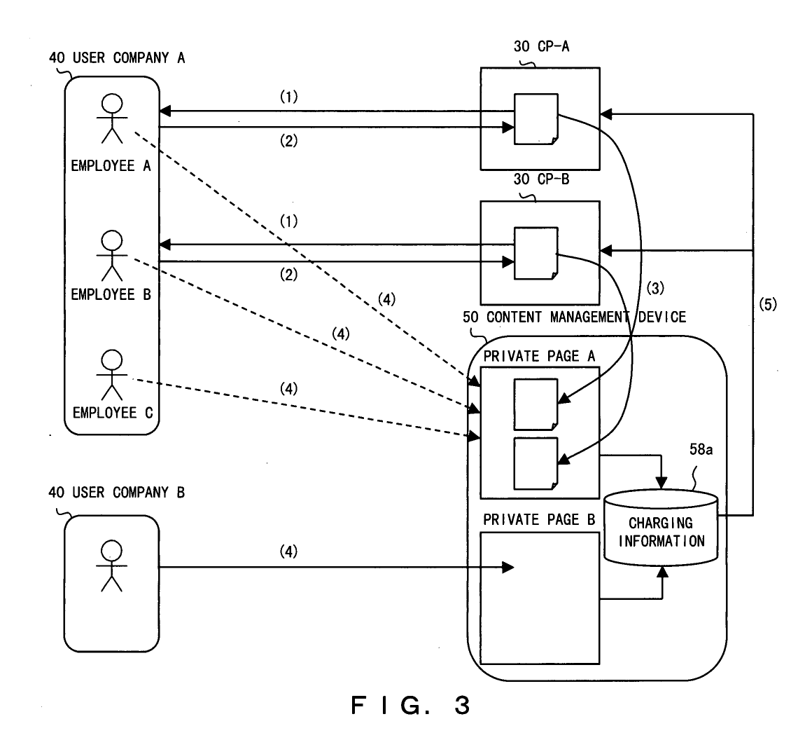

FIG. 3 explains such a service provided by the content management device 50. The service is specifically described below with reference to FIG. 3. In FIG. 3, CP-A and CP-B represent different CPs 30. Hereinafter, when distinguishing CPs from each other, the same description is used.

It is assumed that an employee A of the user company 40 has a contract ID of CP-A30 and does not have contract IDs other than CP-A30. It is assumed that an employee B of the user company 40 has a contract ID of CP-B30 and does not have contract IDs other than CP-B30. It is also assumed that an employee C has no contract IDs with CP 30. In the following example, such employees A through C share content.

Employee A uses the terminal device 42 to access CP-A30 and browses content provided by CP-A30 (sequence (1)). If employee A desires to share the browsed content with employees B and C, employee A requests the sharing (sequence (2)). According to the instruction, information about the content sharing which employee A has requested (hereinafter called “content information”) is transmitted from CP-A30 to the content management device 50 (sequence (3)).

If employee B uses the terminal device 42 to access the content management device 50, the content management device 50 presents the content the sharing of which employee A has requested to be shared. If employee B, who is a sharing partner, browses the presented content, the content management device 50 requests that CP-A30 transmit the content to the terminal device 42 (sequence (4)). If the browsed content is charged, the content management device 50 registers charge information to a charging management database DB) 58a in order to calculate the price. The charging information registered in the DB 58a is provided to CP-A30 at a predetermined time (sequence (5)). This process applies even if another employee is browsing the content, and even if the request to share the content is originated by another employee.

As described above, the sharing of content which is requested is browsed upon demand by the sharing partner. Thus, content needed by its sharing partner are selected. Therefore, if content is charged, waste due to the browsing of content unnecessary for the sharing partner can be avoided.

Since the sharer of content (in this example, an employee) selects content, the content management device 50 collectively manages the sharing of content which is requested, the sharer can browse necessary content at any time, and does not need to manage content. For this reason, content can be very easily shared.

In order to provide the above-mentioned service (hereinafter called a “shared service”), as shown in FIG. 2, the content management device 50 comprises a reception unit 51 for issuing ID/PW to an employee using the service according to an agreement with the user company 40, a user authentication unit 52 for authenticating a user (employee) that uses the terminal device 42 to access the content management device 50, an information input/output unit 53 for inputting/outputting a variety of information including the above-mentioned content information, a content display unit 54 for presenting share requested content, a content sharing unit 55 for enabling an employee to browse content among the presented content, a content charging unit 56 for charging for browsing charged share requested content, and a content discount unit 57 for calculating an amount actually paid to the CP 30 for the browsing if the user company 40 concludes an agreement of discounting the browsing of charged content with the CP 30. A variety of databases constituting a database group 58 are built in a storage unit, which is not shown in FIG. 2.

The content management device 50 comprising the above-mentioned units 51 through 57 is composed of a plurality of servers, such as a Web server, a DB server and the like, which are not shown in FIG. 2. For the storage unit composed of a variety of databases constituting the database group 58, a storage device, such as a hard disk device mounted on or connected to the DB server or the like is used.

However, the CP 30 comprises a user authentication unit 31 for authenticating a user that has accessed the CP 30 via a terminal device 42, a reception unit for issuing ID/PW to an employee that uses the CP 30 according to an agreement with the user company 40, an information inputting/outputting unit 33 for inputting/outputting a variety of information including the above-mentioned content information, a content detection/display unit 34 for presenting content meeting detection condition input by a user, and a sharing instruction unit 35 for enabling a user to instruct the sharing of content. A variety of databases constituting a database group 36 are implemented on a storage unit, which is not shown in FIG. 2.

The CP (information providing system) 30 comprising the above-mentioned units 31 through 36 is composed of a plurality of servers, such as a Web server, a DB server, the content management device 50 and the like. For the storage unit composed of a variety of databases constituting the database group 36, a hard disk device or the like mounted on or connected to the DB server or the like is used.

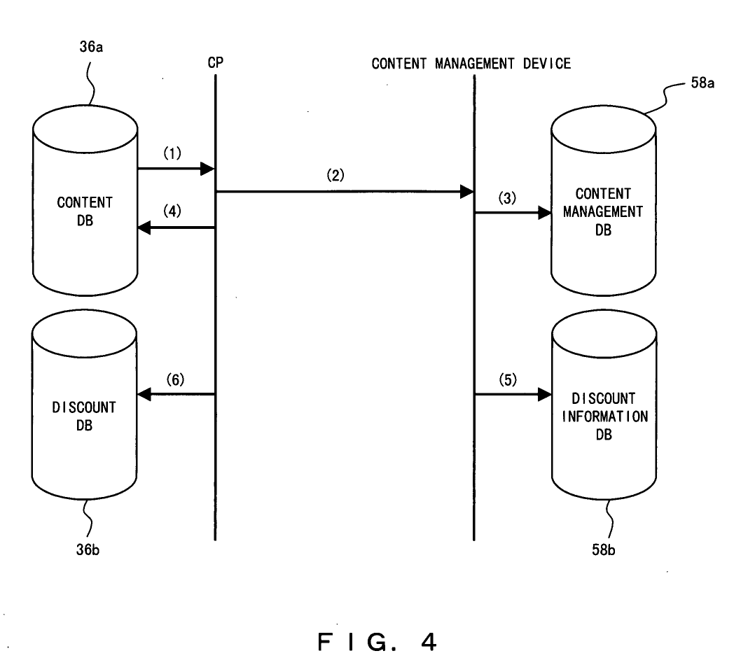

Then, the respective operations of the content management device 50 for realizing the shared service described with reference to FIG. 3, the CP 30 and the terminal device 42 used by the employee of the user company 40 are described in detail with reference to FIGS. 4 through 29.

FIG. 4 shows the sequence of data registration performed when an agreement is concluded between the CP 30 and the content management device 50. The content of the agreement include the scope of the shared service that the content management device 50 can target among content that the CP 30 can provide, how to discount shared access to charged content and the like.

A content DB 36a managed by the CP 30 stores information about content provided by the CP 30 via the Internet 20, such as the title of the content, a URL for accessing the content, a price and the like, in units of content. If an agreement is concluded between the CP 30 and the content management device 50, the CP 30 reads information about content which are the target of the shared service from the content DB 36a (sequence (1)), and then transmits the content information to the content management device 50 (sequence (2)).

Upon receipt of the content information from the CP 30, the content management device 50 attaches a CPID, which is an ID assigned to the CP 30, to each item of content information and registers (stores) the CPID in a content management DB 58b (sequence (3)).

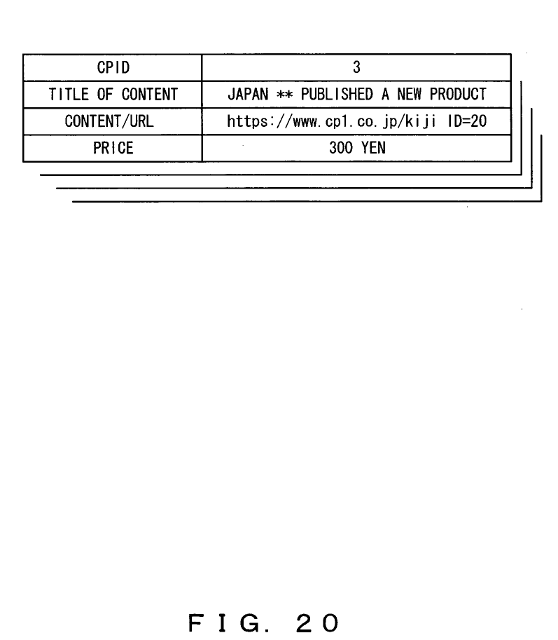

FIG. 20 shows the structure of content information to which a CPID is attached. As shown in FIG. 20, the CPID assigned to the CP 30, the title, URL and price of content are registered in the content DB 56b as content information.

The record of the content DB 36a, in which the content information is registered prepares items for registering a shared target flag indicating whether the content is the target of a shared service, a discount target flag indicating whether the content is the target of a discount. The CP 30 registers the shared target flag in a record that stores each item of content information transmitted to the content management device 50, and discount target flags according to the content of the agreement (sequence (4)).

After completing the registration of the content information in the content management DB 58b, the content management device 50 registers discount information indicating what to discount, in a discount information DB 58c (sequence (5)). Similarly, after completing the registration of flags in the content DB 36a, the CP 30 registers the discount information in a discount information DB 36b (sequence (6)).

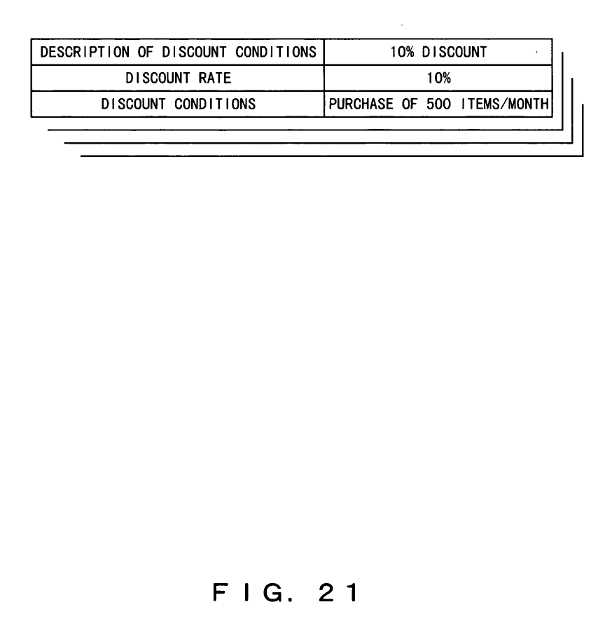

FIG. 21 shows the structure of discount information registered on a discount information DB 58c and 36b in the above-mentioned sequences (5) and (6), respectively.

The discount information is prepared for each type of discount specified by an agreement. For example, as shown in FIG. 21, the discount information is composed of a discount type for uniquely identifying discount information, a discount rate, discount conditions that must be met in order to discount a price (at the discount rate) and the like. In FIG. 21, “500 purchased items/month” indicates that discount cannot be applied unless 500 or more items are accessed within one month.

As described above, if an agreement is concluded between the CP 30 and the content management device 50, information needed to provide a shared service is registered in the respective corresponding DBs of the CP 30 and the content management device 50. Registration and the transmission of information for registration in the CP 30 and the content management device 50 are performed by information input/output units 33 and 53, respectively.

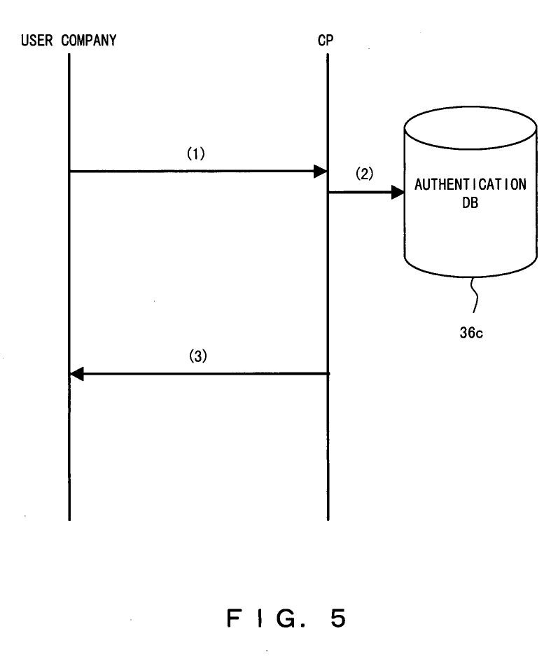

FIG. 5 shows the sequence of data registration performed when an agreement is concluded between the user company 40 and the CP 30. An agreement targets one or more employees.

When desiring to conclude an agreement with the CP 30, the user company 40 applies for an agreement to the CP 30, for example, from the terminal device 42 of a person in charge (for example, a manager) (sequence (1)). The agreement is applied, for example, by inputting and transmitting the personal information of each employee that uses the CP 30, such as a name, an employee number and the like.

Upon receipt of the application, the CP 30 issues ID/PW for each employee, and registers the issued ID/PW as well as the personal information in an authentication DB 36c (sequence (2)). Then, the CP 30 transmits all the issued IPs/PWs to the terminal device 42 of the person in charge (sequence (3)). Such operation of the CP 30 is realized, for example, by the reception unit 32 and the information input/output unit 33.

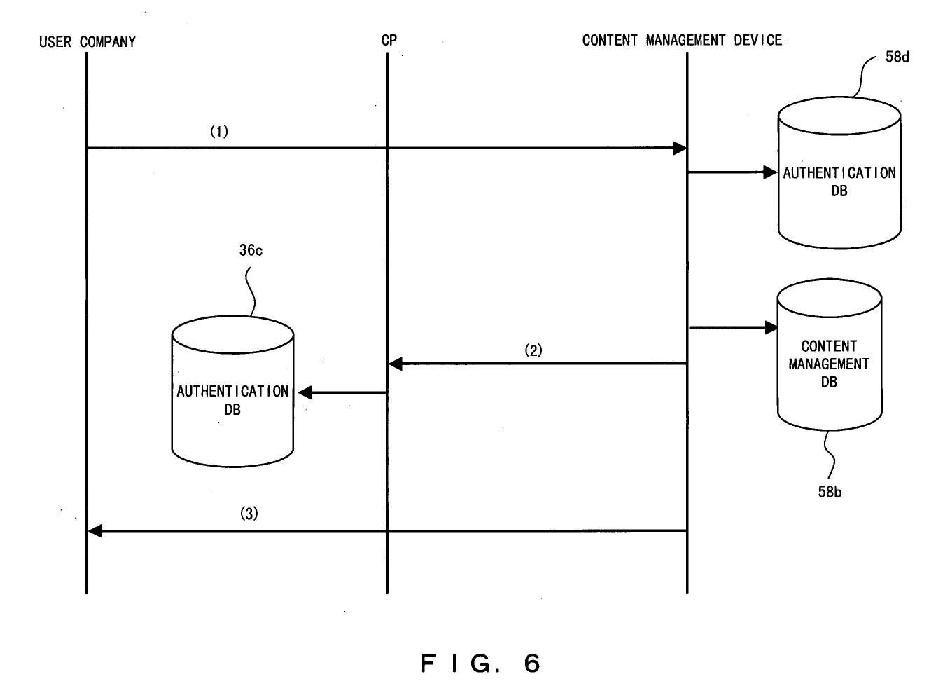

FIG. 6 shows the sequence of data registration performed when an agreement is concluded between the user company 40 and the content management device 50. Since it is preferable to share content between employees whose roles are the same or similar, an agreement targets a lot of employees.

When desiring to conclude an agreement with the content management device 50, the user company 40 applies for an agreement to the content management device 50, for example, from the terminal device 42 of a person in charge (sequence (1)). Since the content to be shared varies depending on roles, the agreement is made for each department/section to which employees using content belong.

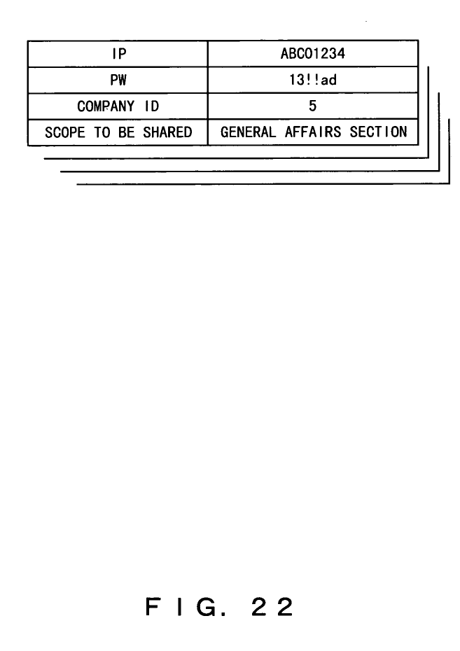

Upon receipt of the application, the content management device 50 issues ID/PW for each employee and registers the issued ID/PW as well as an ID assigned to the user company 40 (company ID) and the department/section in an authentication DB 58d as authentication information. Thus, the authentication DB 58d stores authentication information with a structure shown in FIG. 22, that is, an ID, a PW, the company ID of the user company 40 for which employees work and a department/section to which employees belong and the like for each employee.

The content management device 50 issues an ID/PW for requesting content provided by the CP 30 for each CP 30, and registers the ID/PW as well as other information in a content management DB 58b as access information.

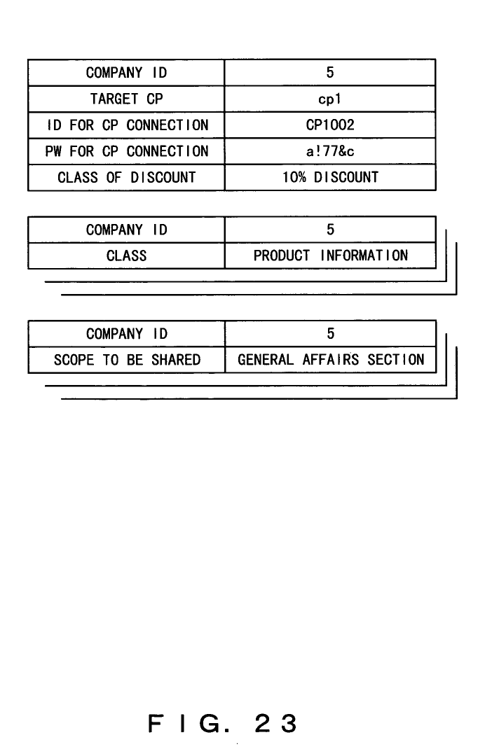

FIG. 23 shows the structure of access information registered on a content management database (DB) 58 b.

As shown in FIG. 23, the access information is largely classified into a table composed of a company ID, identification information indicating a CP 30 to be accessed, ID/PW issued for access, a discount type specified for each item of content provided by the specific CP 30, a first record composed of a company ID and a classification indicating the category of content to be shared by the employee of the user company 40 and a second record composed of a company ID and a shared scope indicating a scope within which contents are shared.

Usually a plurality of first records and a plurality of second records are prepared. Respective company IDs registered in the first and second records correspond to the table. In this preferred embodiment, both the category (classification) of content to be shared by the employee of the user company 40 and its scope to be shared within are predetermined by preparing such first and second records. Thus, each employee can select one of the predetermined categories (classifications) of content and scope to be shared (a group sharing content). Since the scope to be shared is determined based on the organization of the user company 40, that is, the scope is determined in units of sections, the employees that share content constitutes one group.

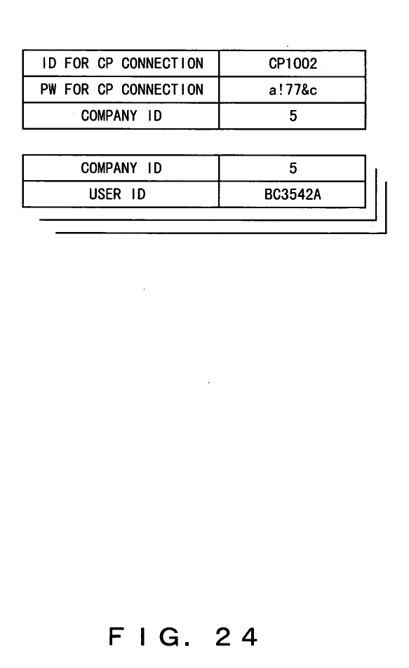

After registering access information shown in FIG. 23 in the content management DB 58b, the content management device 50 notifies a corresponding CP 30 of an ID, a PW and a company ID that constitute the access information (sequence (2)). Upon receipt of the notice, the CP 30 registers them in the authentication DB 36c. In this case, as shown in FIG. 24, both a company ID and an ID that the CP 30 issues to an employee are registered for each employee, with the company ID assigned to the user company 40. It is because of making a user correspond to the user company 40 which concludes an agreement with the CP 30 and to which the content management device 50 assigns a company ID that both a company ID and a user ID are registered for each employee. Namely, it is because of making a user belonging to the user company 40 to which the company ID is assigned corresponds to the company ID.

After notifying the CP 30 of the ID and PW, the content management device 50 notifies the person in charge (manager) of the user company 40 of all the IDs/PWs issued to employees (sequence (3)).

Such operations of the CP 30 and the content management device 50 are realized, for example, by both the reception units 32 and 51, respectively, and the information input/output units 33 and 53, respectively.

No employee of the user company 40 can use a sharing service provided by the content management device 50 until the user company 40 concludes an agreement with each of the CP 30 and the content management device 50, and the CP 30 concludes an agreement with the content management device 50.

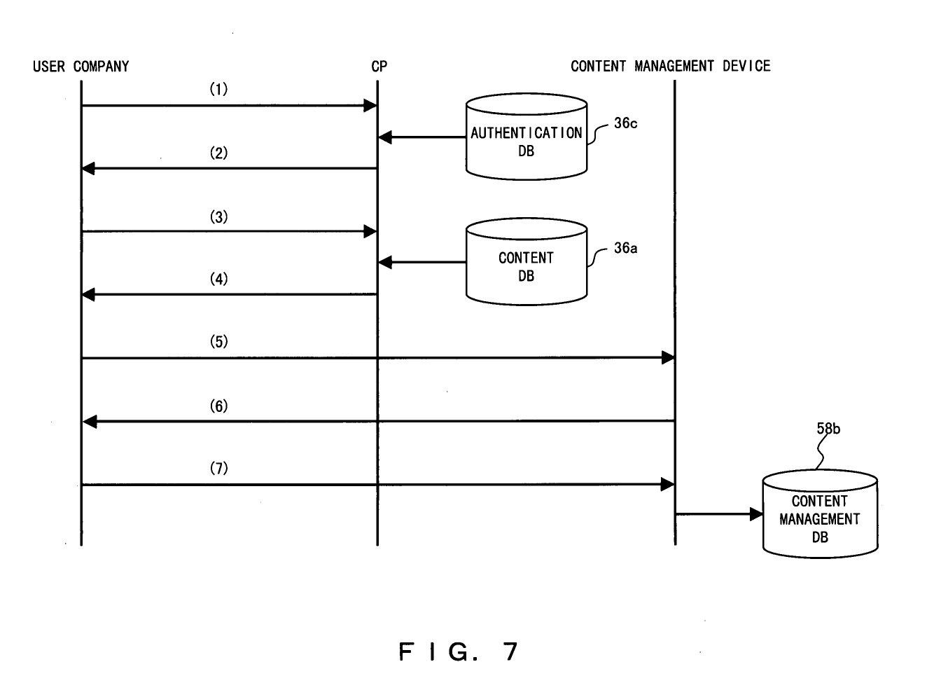

FIG. 7 shows the sequence in the case where the employees of the user company share content provided by the CP 30. The sequence shown in FIG. 7 is obtained by describing in more detail the sequences (1) through (3) shown in FIG. 3.

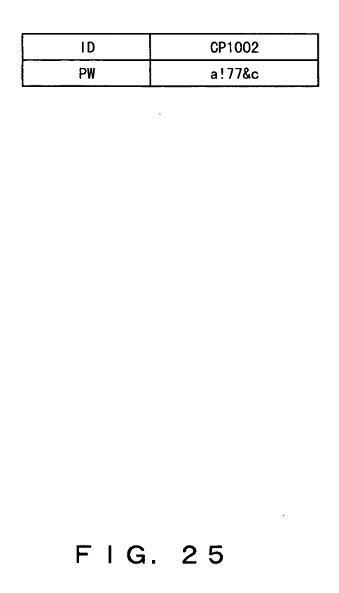

An employee of the user company 40 requests the CP 30 to authenticate the employee by making the terminal device 42 transmit ID/PW shown in FIG. 25, which is issued by the CP 30, to the content management device 50 (sequence (1)). When requested, the CP 30 authenticates the employee by collating the combination of ID/PW received from the terminal device 42 with the combination of ID/PW registered in the authentication DB 36c, and notifies the terminal device 42 of the result of the authentication (sequence (2)). If they agree, the employee can use services provided by the CP 30. In other words, the employee can log in. Such an operation can be realized by a user authentication unit 31.

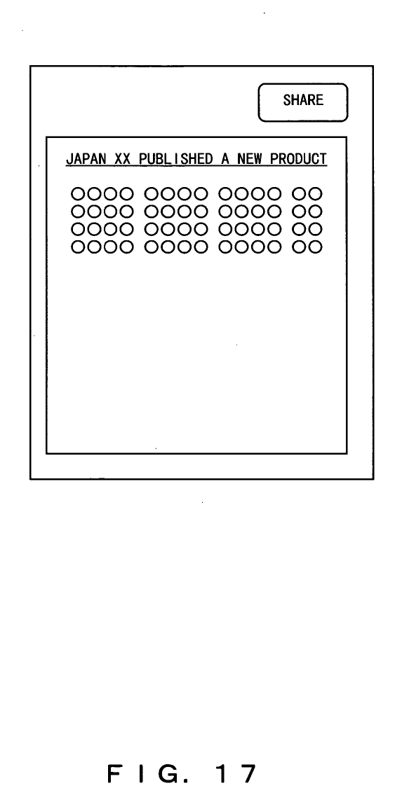

Then, the employee selects the desired content and requests content to browse (sequence (3)). After referring to the content DB 36a in order to collect the price of the requested content, the CP 30 transmits the content to the terminal device 42 (sequence (4)). In this preferred embodiment, the content is transmitted to the terminal device 42 in the form of a content display screen shown in FIG. 17 (as data described in a markup language, such as HTML, etc. This also applies to other screen data.)

As shown in FIG. 17, the content display screen is a frame screen in which contents are displayed. A “share” button for instructing the sharing of its content is displayed outside the frame. If content is requested, the CP 30 generates the display screen shown in FIG. 17 and transmits the screen to the terminal device 42.

In this preferred embodiment, the content management device 50 is set as its link destination by the “share” button. Thus, if the employee (the user of the terminal device 42) clicks the button, the content management device 50 controls the sharing of the content. Instead of displaying the “share” button, a menu item to which the function is assigned can also be displayed. Alternatively, the menu item can be displayed as an icon.

By transmitting the display screen shown in FIG. 17 in which the “share” button is displayed on the terminal device 42, a user desiring to share the content can make such a request very easily and rapidly. In this case, since sharing is now easy, the possibility of not requesting instructing sharing because of difficulty in so doing is greatly reduced. As a result, it is expected that useful content will be frequently. Both the generation of the display screen as shown in FIG. 17 and the browsing of content are realized by both a retrieval/display unit 34 and a sharing instruction unit 35.

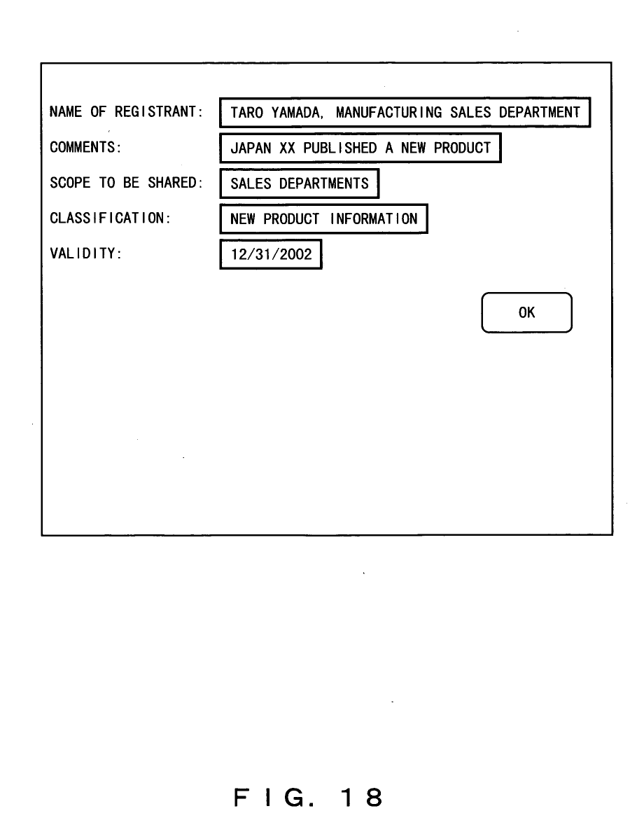

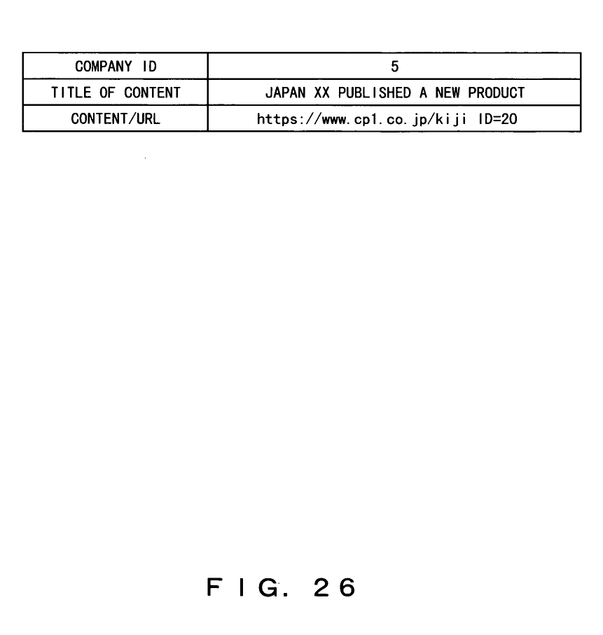

If an employee clicks the “share” button, its terminal device 42 notifies the content management device 50 of the fact (sequence (5)). In this case, as shown in FIG. 26, a company ID, the title of the content and a URL for accessing content are transmitted to the content management device 50 as data for sharing content which has been share requested. For that purpose, the CP 30 displays a description for notifying the content management device 50 of the data, if the “share” button is clicked. Upon receipt of the notice, the content management device 50 transmits a setting screen for sharing shown in FIG. 18 to the terminal device 42 (sequence (6)).

The setting screen for sharing is used when an employee requests the sharing of content to set a variety of preferences necessary for the sharing. As shown in FIG. 18, the name of the registrant (the name of the person that requests sharing), comments, a sharing scope, a classification and validity are its settings. If the employee desires to share content, it is sufficient for the employee to input data to each box displayed for the settings, and then to click an “OK” button. The data that is input to each setting item is called “incidental registration information” hereinafter.

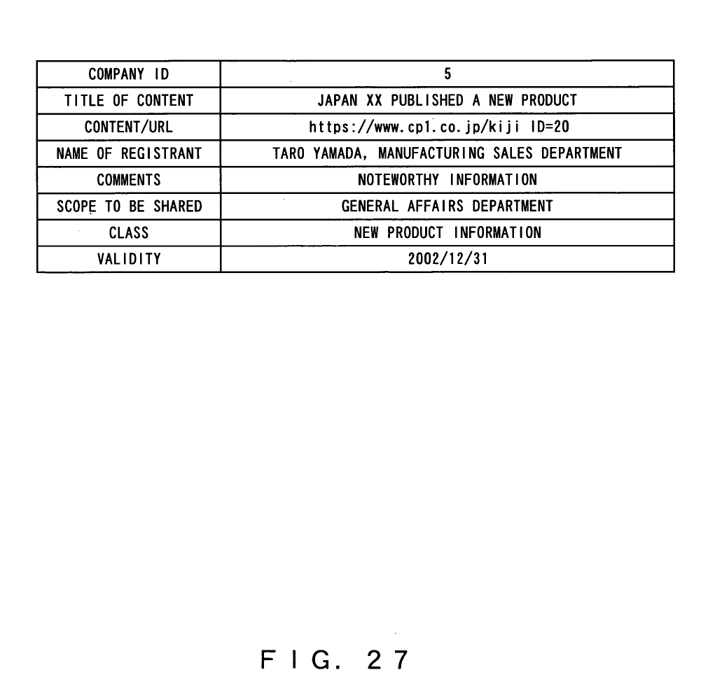

When selecting the “OK” button after inputting data to each box, as shown in FIG. 27, the terminal device 42 notifies the content management device 50 of the incidental registration information, which is the set of data in each setting field, input on the setting screen and the company ID, the title of the content and the URL for accessing the content (sequence (7)). The content management device 50 registers the received data in the content management DB 58b. The company ID, the title of content and the like are described on the sharing setting screen so as to be included in the notification, for example, by clicking the “OK” button. The data shown in FIG. 27 is called “content sharing information” hereinafter.

By registering the content sharing information in the content management DB 58b, content the sharing of which is requested, can be shared. After completing the registration, the content management device 50 notifies the employee that has requested the sharing that the sharing process has completed by notifying the terminal device 42 (not shown in FIG. 7). This process is realized by content sharing unit 55.

In this preferred embodiment, by clicking the “share” button, the terminal device 42 transmits push information to the content management device 50. In other words, by the click, control is transferred to from the CP 30 to the content management device 50. However, the transfer can also be made by the control of the CP 30. Specifically, upon the receipt of the push information, the CP 30 can transfer necessary information to the content management device 50 and the content management device can control the further processes.

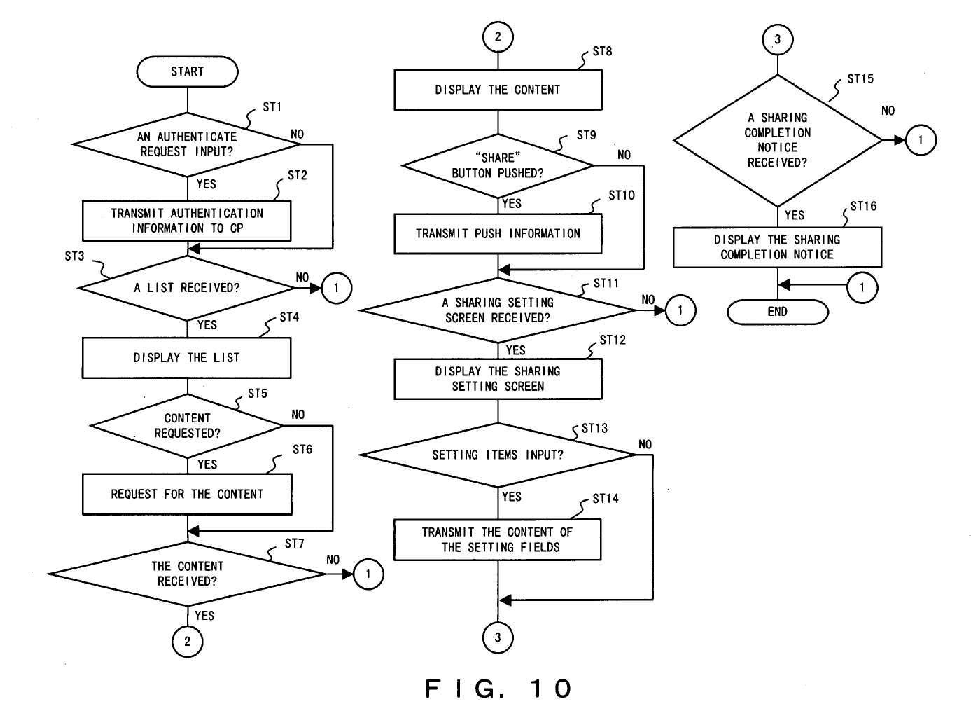

If sharing is requested the sequence shown in FIG. 7, each of the terminal devices 42 of the employees of the user company 40, the CP 30 and the content management device 50 performs the following process. The processes are described in detail with reference to a variety of flowcharts shown in FIGS. 10 through 12.

FIG. 10 is a flowchart showing the processes of the terminal device 42 in the case where a user requests the sharing of content. In FIG. 10, a process for realizing the sequence shown in FIG. 7 is excerpted and detailed, and its flow is shown. Firstly, the process of the terminal device 42 in that case is described in detail with reference to FIG. 10.

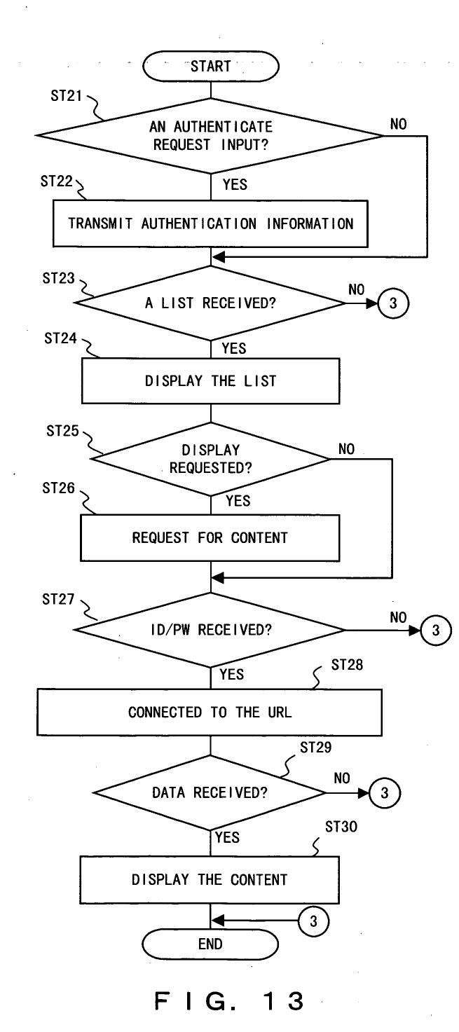

The process performed in the flowchart of FIG. 10 is realized, for example, if a central processing unit (CPU) mounted on the terminal device 42 executes the program of an operating system (OS) stored on a hard disk device, a browser or the like. This also applies to FIG. 13, which is described later.

The CP 30, for example, transmits an authentication screen to a terminal device that accesses and requests the terminal device to input its IP/PW. The authentication screen is provided with, for example, boxes for inputting IDs and PWs, a variety of buttons, such as an “OK” button, a “cancel” button. A process performed after displaying the authentication screen on a display device mounted or connected to the terminal device 42 is described below.

Firstly, in step ST1, it is determined whether the “OK” button has been clicked in a state where the ID/PW needed to request authentication have been input. If a user clicks the “OK” button after inputting the ID/PW, the determination is yes and in step ST2, the ID/PW is transmitted to the CP 30 as authentication information, and the process proceeds to step ST3. Otherwise, the determination is no, and the process immediately proceeds to step ST3. The sequence (1) shown in FIG. 7 can be realized thus.

Upon receipt of the authentication information, the CP 30 transmits the result of authentication based on the information to the terminal device 42. If the result is OK, the CP 30 transmits, for example, a screen on which a list of accessible content is displayed (hereinafter called “content list screen”) as well as the result (sequence (2) shown in FIG. 7). Therefore, the reception of the screen means that the authentication result is OK.

For this reason, in step ST 3, the terminal device 42 determines whether the content list screen has been received from the CP 30. If the authentication result is OK, the CP 30 transmits the content list screen. Therefore, the determination becomes yes, and the process proceeds to step ST4. Otherwise, the determination becomes no, and the series of processes for realizing the sequence shown in FIG. 7 terminate.

In step ST4, the content list screen received from the CP 30 is displayed on a display device. In step ST5, it is determined whether the content is requested. If the user clicks any content displayed in the list on the content list screen, the determination is yes, and in step ST6, the content is requested from the CP 30 (sequence (3) shown in FIG. 7). And, the process proceeds to step ST7. Otherwise, the determination is no, and the process proceeds directly to step ST7.

In step ST7, it is determined whether the content has been received. In this case, the content is received from the CP 30 in the form of the screen on which the “share” button is displayed. If the screen is received (sequence (4) shown in FIG. 7), the determination is yes, and the process proceeds to step ST8. Otherwise, the determination is no, and the processes terminate.

In step ST8, the content received in the form of a content display screen is displayed on a display device. Then, in step ST9, it is determined whether the “share” button has been clicked (depressed). If the button is clicked, the determination is yes, and the process proceeds to step ST 10, and the content management device 50 is notified (sequence (5) shown in FIG. 7). In this case, as described above, data, such as a company ID, the title of the content, and a URL for accessing the content and the like are also transmitted to the content management device 50. Hereinafter, such data is called “push information”. The process proceeds to step ST11. However, if, the determination is no, and the process in step ST11 is performed directly.

In step ST11, it is determined whether a sharing setting screen shown in FIG. 18 that is transmitted by the content management device 50 has been received, by receiving the push information. If the sharing setting screen is received (sequence (6) shown in FIG. 7), the determination is yes, and the process proceeds to step ST12. Otherwise, the determination is no, and the process terminates.

In step ST12, the received sharing setting screen is displayed on a display device. The input/display of data to a box displayed on the screen is made according to a user's operation. If the user clicks the “OK” button, the process proceeds to step ST13, and it is determined whether data is input to each box on the screen. If a user clicks the “OK” button after inputting data to each box, the determination is yes, and the process proceeds to step ST14. In step ST14, the data input to each box is transmitted to the content management device 50 as incidental registration information (sequence (7) shown in FIG. 7). In this case, a company ID, the title of the content and a URL for accessing the content are also transmitted. Then, the process proceeds to step ST15. However, if data is not input to a box to which data should be input, the determination is no, and the process in step ST15 is performed.

Upon receipt of such data, the content management device 50 registers the data in the content management DB 58b, and notifies the terminal device 42 that the process of sharing content has been completed. Therefore, in step ST15, it is determined whether the notice (sharing completion notice) has been received. If the notice is received, the determination is yes, and the process terminates after displaying the notice on a display device instep ST6. Otherwise, the determination is no, and the process terminates.

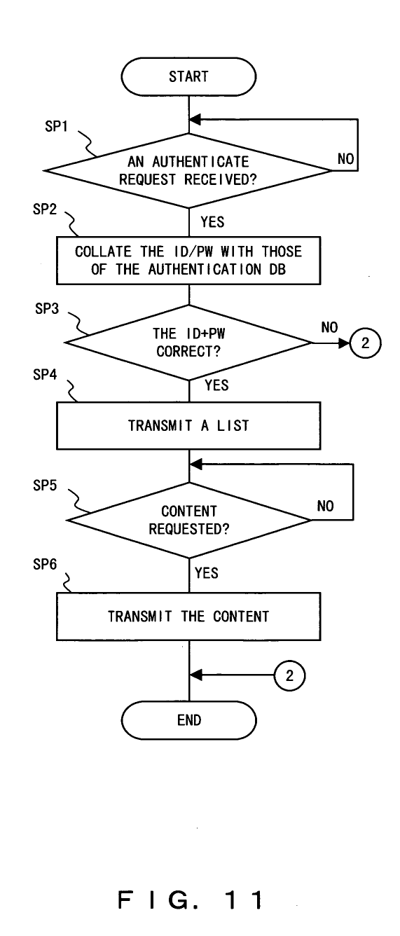

FIG. 11 is a flowchart showing the process of the CP 30 in the case where a user requests the sharing of content. In FIG. 11, the process for realizing the sequence shown in FIG. 7 is excerpted and detailed, and its flow is shown. Next, the process of the CP 30 in that case is described in detail with reference to FIG. 11.

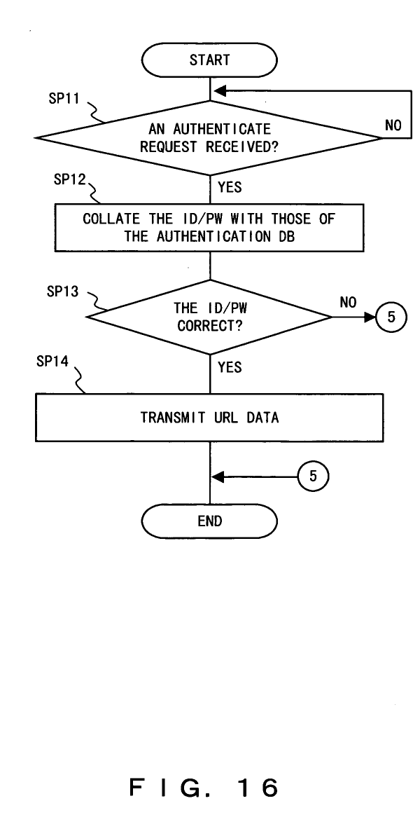

If an information providing system for providing services using the CP 30 is composed of a plurality of servers, a CPU mounted on each server can perform the process shown in the flowchart of FIG. 11, by executing a program (such as a network OS, an application program, etc.) stored in, for example, a hard disk device. This also applies to FIG. 16, which is described later.

Firstly, in step SP1, an authentication request from the terminal device 42 is awaited. If an ID/PW are received from the terminal device 42 as authentication information (sequence (1) shown in FIG. 7), the determination is yes, and the process proceeds to step SP2. In step SP2, the ID/PW is collated with those registered in the authentication DB 36c and the process proceeds to step SP3.

In step SP3, it is determined whether the received ID/PW is correct. If the received ID/PW is registered in the authentication DB 36c, the determination is yes, and the process proceeds to step SP4. In step SP4, the result of the authentication is regarded to be OK, and a content list screen is transmitted to the terminal device 42 (sequence (2) shown in FIG. 7). Then, the process proceeds to step SP5. Otherwise, the determination is no, and the process terminates.

In step ST5, a request for content from the terminal device 42 is awaited. If the request is received (sequence (3) shown in FIG. 7), the process proceeds to step ST6. In step ST6, the content display screen shown in FIG. 17 on which both the requested content and the “share” button are displayed is generated and is transmitted to the terminal device 42 (sequence (4) shown in FIG. 7). On the display screen, as described above, a description for notifying the content management device 50 of a company ID, the title of the content, a URL for accessing content and the like is displayed by clicking the “share” button.

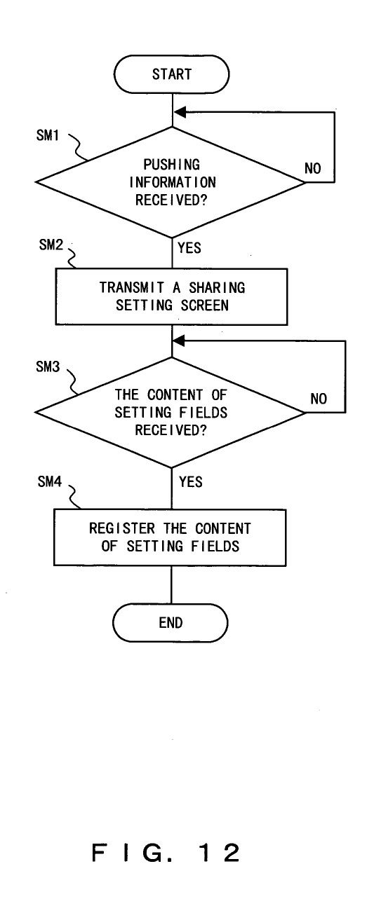

FIG. 12 is a flowchart showing the process of the content management device 50 in the case where a user instructs the sharing of content. In FIG. 12, the process for realizing the sequence shown in FIG. 7 is excerpted and detailed, and its flow is shown. Next, the process of the content management device 50 in that case is described in detail with reference to FIG. 12.

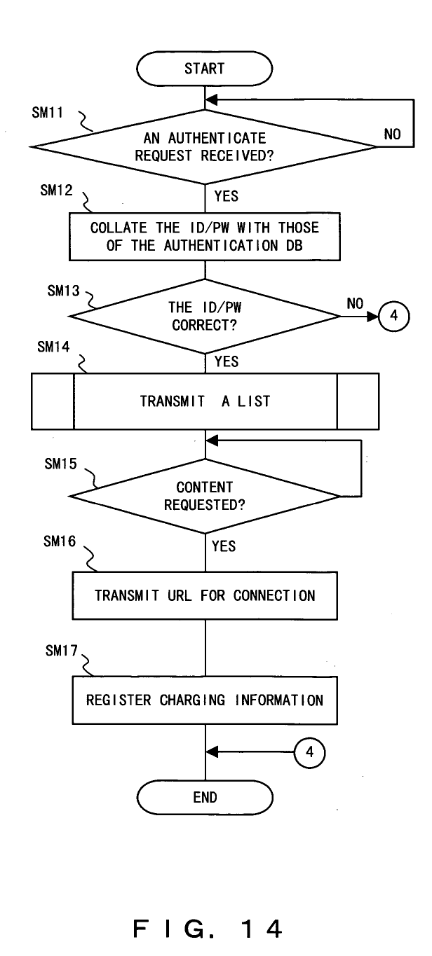

For example, if the content management device 50 is composed of a plurality of servers, a CPU mounted on each server can perform the process shown in the flowchart of FIG. 12 by executing a program (such as a network OS, an application program, etc.) stored on, for example, a hard disk device. This also applies to FIG. 14, which is described later.

Firstly, in step SM1, the reception of push information from the terminal device 42 is awaited. If the push information is received (sequence (5) shown in FIG. 7), the process proceeds to step SM2. In step SM2, the sharing setting screen shown in FIG. 18 is generated and is transmitted to the terminal device 42 (sequence (6) shown in FIG. 7).

On the sharing setting screen, a “scope to be shared” and a “classification” can be selected from choices displayed in a box, which are displayed by clicking on a pull-down button. The choices vary by a user company 40. Therefore, the sharing setting screen is generated by selecting the choices, according to the company ID received from the terminal device 42.

In step SM3 to which the process proceeds after transmitting the sharing setting screen, the reception of content sharing information (see FIG. 27) including incidental registration information input on the screen is awaited. If the data is received (sequence (7) shown in FIG. 7), the process proceeds to step SM4. In step SM4, the data is registered in the content management DB 58b, and a sharing completion notice is transmitted to the terminal device 42. Then, the process terminates.

As described above, if the user of the terminal device 42 requests the sharing of content, a variety of data needed to access the content as well as the incidental registration information input by the user are registered in the content management DB 58b. Thus, the content can be shared with persons specified, by a user using the incidental registration information.

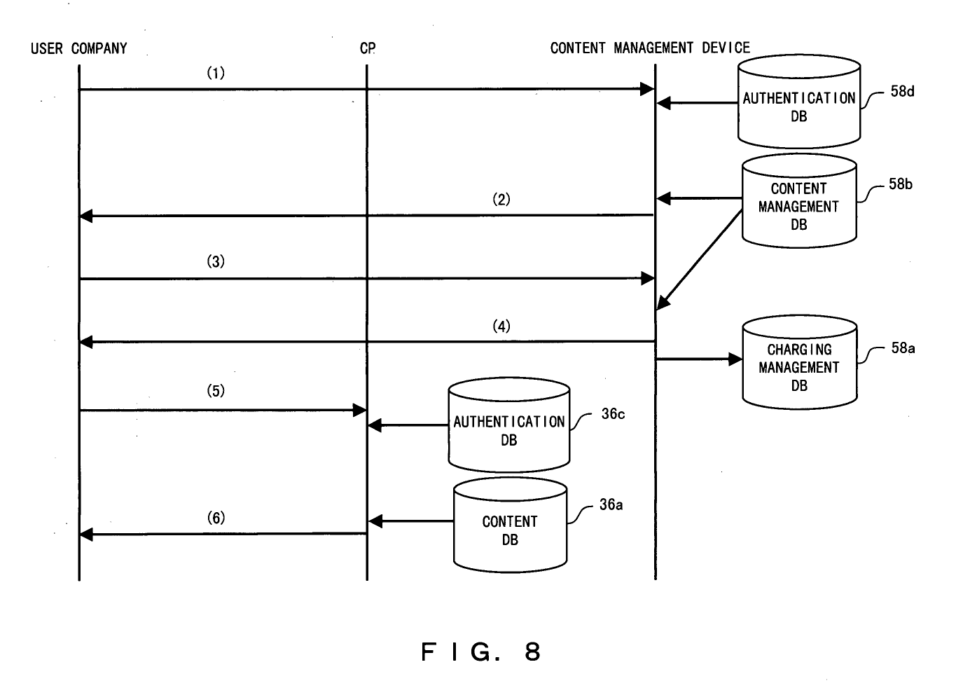

FIG. 8 shows the sequence in the case where the employee of the user company 40 accesses content shared by the content management device 50. FIG. 8 can be obtained by more specifically showing the sequence (4) shown in FIG. 3.

The employee of the user company 40 requests the content management device 50 to authenticate the employee by making the terminal device 42 transmit its ID/PW issued by the content management device 50 to the content management device 50 as authentication information (sequence (1) shown in FIG. 7).

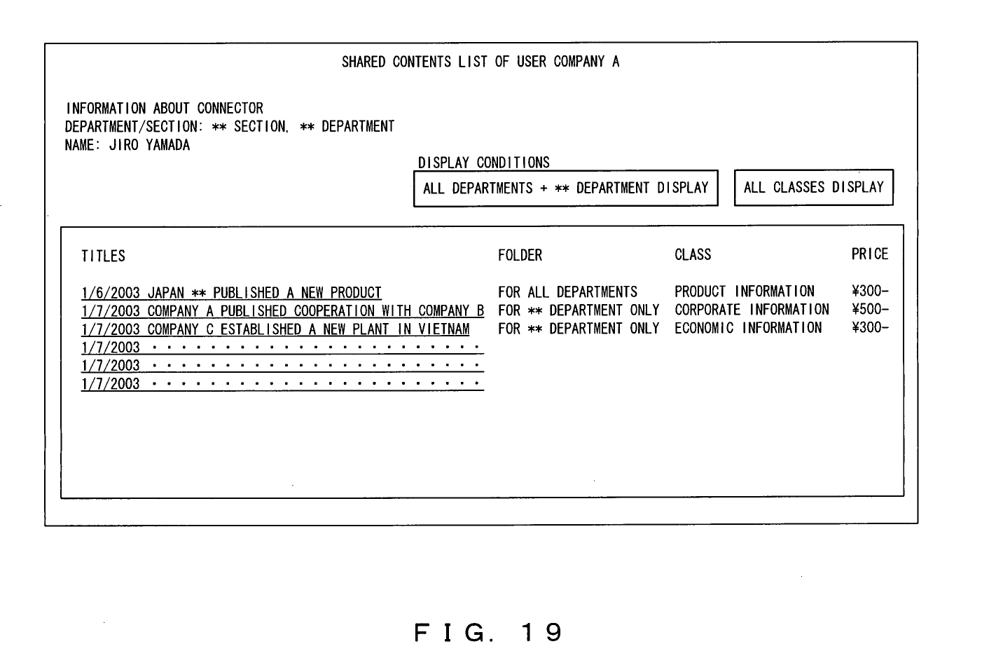

When requested, the content management device 50 authenticates the employee by collating the combination of the ID/PW received from the terminal device 42 with those registered in the authentication DB 58d. If the result of the authentication is OK, the content management device 50 extracts the sharing information of content presented to the employee by retrieving data from the content management DB 58b using the company ID of the user company 40 to which the employee belongs and the relevant scope to be shared (see FIG. 22), generates the content list screen shown in FIG. 19, using the extracted sharing information and transmits the screen to the terminal device 42 (sequence (2)). This is realized by the content display unit 54.

On the content list screen, the title of the content which is instructed to be shared by the relevant or another employee, folders which shows the scope to be shared, a classification, a price and the like are provided for each item of content. The user of the terminal device 42 requests the browsing of content by clicking the desired content in the list (sequence (3)).

Each of “all departments+**Department display” and “all classes display” indicates content displayed in each box. These boxes are prepared so that a user can select display conditions for specifying the scope of content to be displayed. Since specifiable conditions vary depending on a user, the conditions can be input to each box, for example, by selecting a desired choice from the choices displayed in the box that are displayed by a drop-down menu.

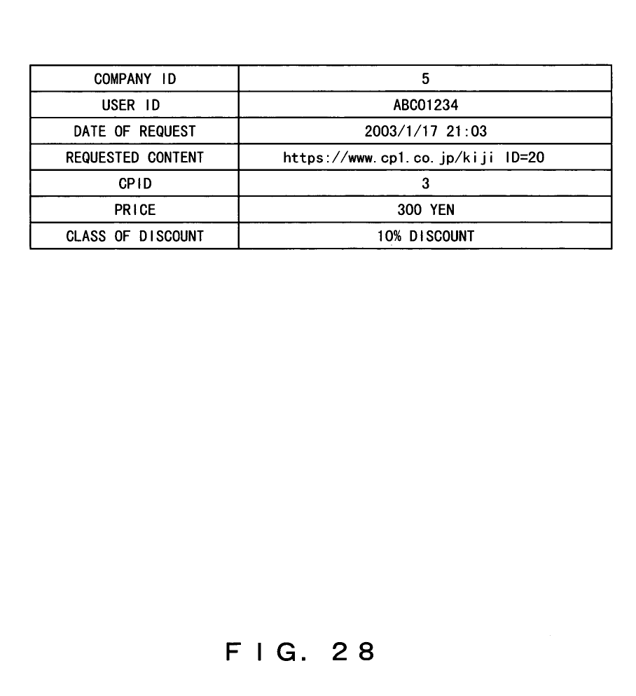

When the browsing of content is requested, the content management device 50 extracts an ID/PW (see FIG. 23) needed to request the CP 30 that provides the content to present the content, from the content management DB 58b, and transmits the ID/PW as well as a URL for access to the terminal device 42 as hidden parameters (sequence (4)). The extraction is executed using the company ID of the user company 40 to which the user of the terminal device 42 belongs and the identification information of the CP 30 that provides the content requested by the user as keys (see access information shown in FIG. 23). In order to collect a price associated with the provision of content from the user company 40, the CP 30 registers a variety of data shown in FIG. 28 in the charging management DB 58a as charging information. The registration of the charging information is realized by the content charging unit 56.

Upon receipt of the ID/PW from the content management device 50, the terminal device 42 transmits the ID/PW as well as a URL to the CP 30 and requests content specified by the URL (sequence (5)).

When receiving the ID/PW from the terminal device 42 thus, the CP 30 determines whether the combination is correct, by collating the ID/PW with the ID/PW registered in the authentication DB 36c in the sequence (2) shown in FIG. 6. If it is determined that the combination is correct, the result of the authentication is regarded to be OK and the content DB 36a is referenced, the content requested by the received URL are transmitted to the terminal device 42 (sequence (6)).

When an employee accesses the content shared in the sequence shown in FIG. 8, each of the terminal devices 42 used by the employees of the user company 40, the CP 30 and the content management device 50 performs the following process. The processes are described in detail with reference to FIGS. 13 through 16.

FIG. 13 is a flowchart showing the processes of the terminal device 42 in the case where a user accesses shared content. In FIG. 13, the process for realizing the sequence shown in FIG. 8 is excerpted and detailed, and its flow is shown. Firstly, the process of the terminal device 42 in that case is described in detail with reference to FIG. 10.

The content management device 50, for example, transmits an authentication screen to the terminal device 42 that accesses the content management device 50 and requests the terminal device 42 to input an ID/PW. The authentication screen is provided with, for example, respective boxes for inputting an ID and a PW, “OK” and “cancel” buttons, and the like. A process performed after displaying the authentication screen on a display device mounted or connected to the terminal device 42 is described below.

Firstly, in step ST21, it is determined whether the “OK” button is clicked in the state where ID/PW needed to request for authentication is input. If a user clicks the “OK” button after inputting the ID/PW, the determination is yes. Then, in step ST22, the ID/PW are transmitted to the content management device 50 as authentication information, the process proceeds to step ST23. Otherwise, the determination is no, and the process immediately proceeds to step ST 23. The sequence (1) shown in FIG. 8 can be realized thus.

Upon receipt of the authentication information, if the result of authentication performed based on the information is OK, the content management device 50 transmits, for example, the content list screen shown in FIG. 19 to the terminal device 42. Therefore, in step ST23, it is determined whether the content list screen has been received from the content management device 50. If the result of the authentication is OK, the content list screen is transmitted to the content management device 50 (sequence (2) shown in FIG. 8). Then, the determination becomes yes, and the process proceeds to step ST 24. Otherwise, the determination becomes no, and the series of the processes for realizing the sequence shown in FIG. 8 terminates.

In step ST24, the content list screen received from the content management device 50 is displayed on a display device. Then, in step ST 25, it is determined whether content has been requested. If a user selects any content displayed in the list on the content list screen, the determination is yes, and in step ST 26, the content is requested from the content management device 50 (sequence (3) shown in FIG. 8). The process proceeds to step ST27. Otherwise, the determination is no, and the process immediately proceeds to step ST27.

In step ST27, it is determined whether the ID/PW and a URL have been received. If they are received (sequence (4) in FIG. 8) the determination is yes, and the process proceeds to step ST 28. Otherwise, the determination is no, and the process terminates.

In step ST28, the received ID/PW and URL are transmitted to the CP 30 (sequence (5) shown in FIG. 8). Thus, after requesting a connection to the server via the URL, the process proceeds to step ST29, and it is determined whether the data of the URL, that is, content desired by the user has been received. If the content is received from the CP 30 (sequence (6) shown in FIG. 8), the determination is yes. Then, after displaying the content on a display device in step ST 30, the process terminates. Otherwise, the determination is no, and the process terminate immediately.

FIG. 14 is a flowchart showing the process of the content management device 50 in the case where a user accesses shared content. In FIG. 14, the process for realizing the sequence shown in FIG. 8 is focused and excerpted, and its flow is shown. Next, the process of the content management device 50 in that case is described in detail with reference to FIG. 14.

Firstly, in step SM 11, the reception of authentication information from the terminal device is awaited. If the ID/PW are received (sequence (1) shown in FIG. 8), the process proceeds to step SM 12, and the ID/PW are collated with those registered in the authentication DB 58d. Then, in step SM 13, it is determined whether the received ID/PW is correct. If the received ID/PW agree with those registered in the authentication DB 58d, the determination is yes, and the process proceeds to step SM14. Otherwise, the determination is no, and the process terminates.

In step SM14, a list transmitting process of generating and transmitting the content list screen shown in FIG. 19 is performed (sequence (2) shown in FIG. 8). Then, the process proceeds to step SM15.

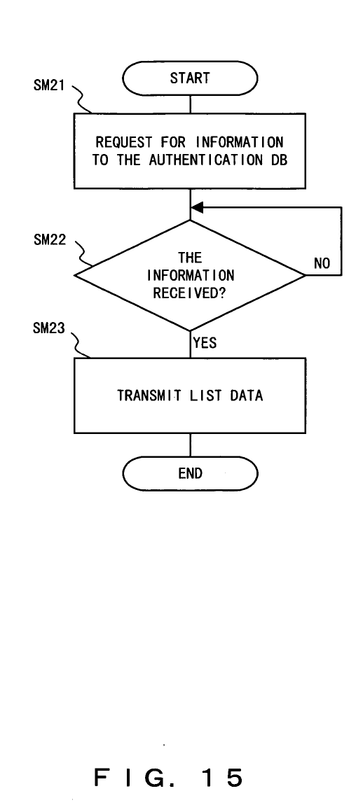

The list transmitting process is described in detail below with reference to the flowchart shown in FIG. 15.

Firstly, in step SM21, the authentication DB 58d is accessed, and both the ID of a company to which the employee that it has been the employee works for confirmed and its scope to be shared are extracted (see FIG. 22). Then, in step SM22, the extraction of the information is awaited. If the information is extracted, the process proceeds to step SM23.

Instep SM23, content sharing information (see FIG. 27) for sharing content is extracted by retrieving data from the content management DB 58b using the extracted company ID and scope to be shared as keys. Then, the content list screen shown in FIG. 19 is generated using the extracted sharing information, and is transmitted to the terminal device 42 (sequence (2) shown in FIG. 8). The process terminates. After transmitting the content list screen to the terminal device 42 thus, the process proceeds to step SM15.

In step. SM15, a request for the content from the terminal device 42 is awaited. If the content is requested (sequence (3) shown in FIG. 8), the process proceeds to step SM16, and a URL for accessing the content and ID/PW (see FIG. 23) are transmitted to the terminal device 42 (sequence (4) shown in FIG. 8). Then, in step SM17, charging information shown in FIG. 28 is generated based on the authentication result, the requested content and current time, and is registered in the charging information DB 58a. Then, the process terminates.

FIG. 16 is a flowchart showing the process of the CP 30 in the case where a user accesses shared content. In FIG. 16, the process for realizing the sequence shown in FIG. 8 is excerpted and detailed, and its flow is shown. Next, the process of the CP 30 in that case is described in detail with reference to FIG. 16.

Firstly, in step SP11, an authenticate request from the terminal device 42 is awaited. In this case, the targets of the authenticate request are an ID/PW and a URL. If such data is received from the terminal device 42 as authentication information (sequence (5) shown in FIG. 8), the determination is yes, and the process proceeds to step SP12. In step SP12, the received ID/PW is collated with those registered in the authentication DB 36c (see FIG. 24). Then, the process proceeds to step SP13.

In step SP13, it is determined whether the received ID/PW is correct. If the received ID/PW agree with those registered in the authentication DB 36c, the determination is yes, and the process proceeds to step SP14. In step SP14, the result of the authentication is regarded to be OK, and the URL data received as authentication information is transmitted to the terminal device 42 (sequence (6) shown in FIG. 8). Then, the series of the processes terminate. However, otherwise, the determination is no, and the series of the processes terminate immediately.

As described above, if a user accesses the content management device 50 from their terminal device 42 and requests the content presented by the content management device 50, the content is transmitted from the CP 30 to the terminal device 42. Thus, shared content can be accessed at any time.

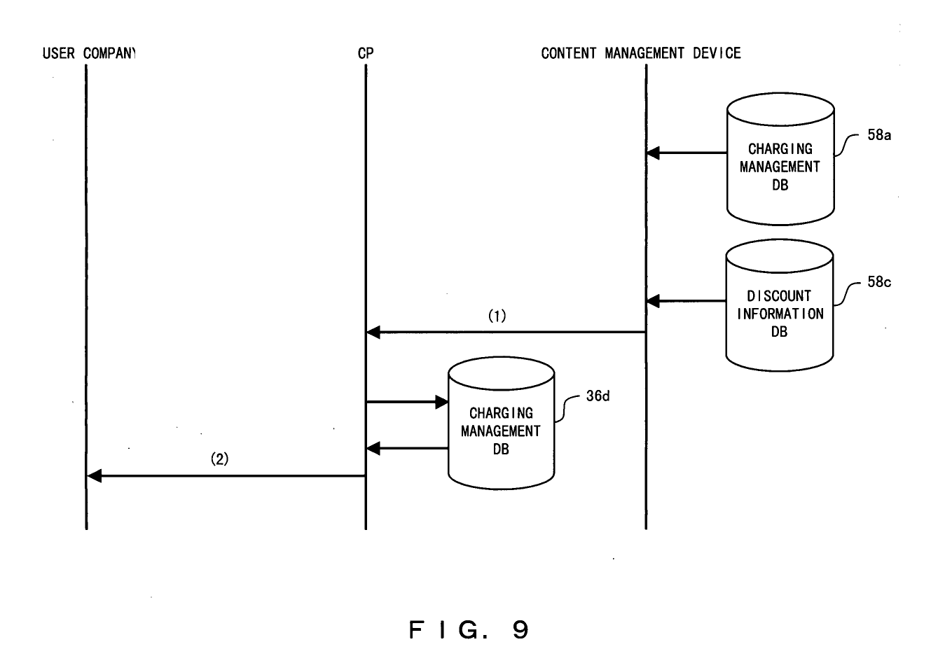

FIG. 9 shows the sequence in the case where the content management device 50 provides the CP 30 with charging information. Charging information is used for the CP 30 to collect a price caused by the presentation of content. The sequence shown in FIG. 9 can be obtained by more specifically describing the sequence (5) shown in FIG. 3 in greater detail.

The content management device 50 provides the CP 30 with charging information at a predetermined time. In order that, charging information which has ID of CP 30 is extracted from the charging information DB 58a. Thus, the content information registered in the sequence (3) shown in FIG. 4 (see FIG. 20) and the access information registered in the sequence (1) shown in FIG. 6 (see FIG. 23) are extracted from the content management DB 58b, and discount information corresponding to a discount type in the access information (see FIG. 21) is extracted from the discount information DB 58c.

After extracting information from each DB 58a through c, the charging information extracted from the charging information DB 58a is processed according to the discount information extracted from the discount information DB 58c, and an amount that the CP 30 can claim for the user company 40 is calculated for each user company 40. For example, if the discount information shown in FIG. 21 is extracted from the discount information DB 58c, the number of charged items extracted from the charging information DB 58a (number of accesses) is counted for all content, and a total price for all content is calculated by multiplying the price of each item in the content information by its respective count value. By summing the subtotal prices, a total claim amount before discount for the user company 40 is determined. Then, it is determined whether the total value of count values for all content meets the discount conditions, and the total claim amount after discount is calculated according to the result of the determination. The total claim amount after discount calculated thus is transmitted to the CP 30 for each company as charging information (sequence (1)). The calculation of such a claim amount is performed by the content discount unit 57.

Upon receipt of the charging information from the content management device 50 thus, the CP 30 registers the charging information in the charging management DB 36d. Then, the price is claimed for the user company 40, according to the charging information registered in the charging management DB 36d (sequence (2)).

Although the above description presumes that the CP 30 claims prices for each user company 40, the prices can also be claimed for each employee section (scope to be shared) or each employee. Although in the above description, the content management device 50 manages charging information associated with the provision of content, the management can also be assigned to the CP 30.

Since in the above description, it is assumed that a shared service is provided for the user company 40, a scope to be shared is selected from predetermined choices. However, there is no need to limit the scope to be shared so. In other words, a scope to be shared can be arbitrarily set.

Although in the above description, content to be shared are provided from the CP 30 to the terminal device 42 via the content management device 50, there is not always a need to do so. For example, the content management device 50 can also obtain shared content, and provide the content to the terminal device 42.

Although in the above description, shared content are presented by automatically transmitting the content list screen shown in FIG. 19 to the terminal device 42 that accesses the content management device 50, another method can also be adopted. For example, shared content can also be presented by electronic mail or the like. Shared content can be presented according to the user (employee) request.

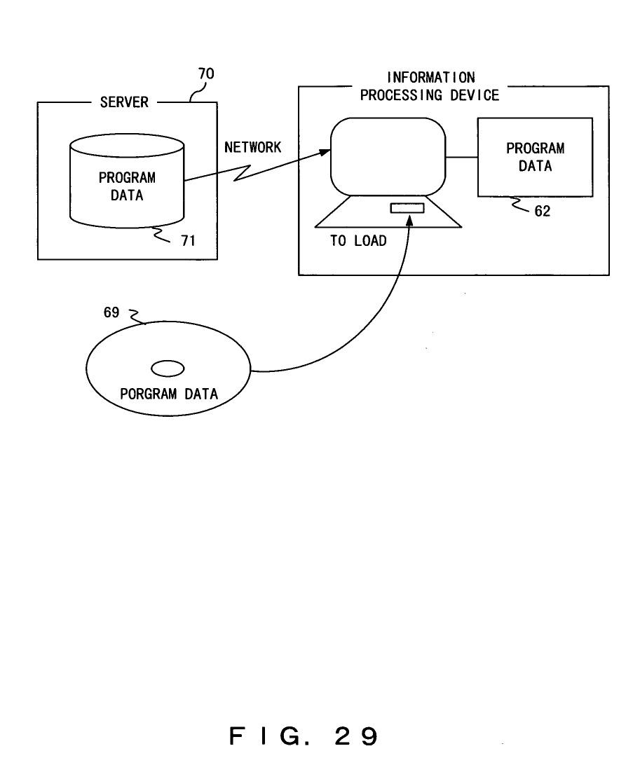

As shown in FIG. 29, program data for realizing the above-mentioned operation of the content management device or its variations can also be recorded on a storage medium 69, such as a compact disk-read only memory (CD-ROM), a digital versatile disk (DVD), a magneto-optical disk or the like and be distributed. Alternatively, a server 70 can distribute a part of the program data or the entire program data via a transmission medium used in a public network or the like. In such a case, a user can realize the content (information) management device of the present invention, using the information processing device by obtaining the program data and loading it on to a computer as the information processing device.

As described above, the present invention enables a person specifying the users of the terminal devices 42 to provide access of shared content, as members belonging to a group, enables the user of a terminal devices obtain at least information related to information that the user of the terminal specifies as information to be shared by the group, among information provided by an information providing system via a communication network, and enables the users of the terminal devices to share the information to be shared by the group, using the related information.

Thus, by presenting information to be shared, any user belonging to the same group can access the information, and the information can be easily accessed. Accordingly, content can be more easily accessed while the collection of a price associated with the sharing of double charged content (information) by a sharing partner is avoided.

If the user of the terminal device selects presented information to be shared and the information to be shared is transmitted to the user, the information can be easily accessed.

1. An information providing method for an information management device enabling the terminal device of a user belonging to a group and desiring access to the same information as other members of the group, to access information provided by an information providing system via a communication network, comprising:
receiving a notice for specifying information accessed by a user of a terminal device belonging to a group of information provided by the information providing system as information to be shared by the group and information for accessing the information to be shared, from a user of a terminal device; and
transmitting information for accessing the information to be shared to a user of a terminal device belonging to the group in response to a request for information for accessing the information to be shared from a user of a terminal device belonging to the group.

2. An information providing method for an information providing system providing information via a communication network, comprising:
generating a picture or display indicating a command to specify the information as the information to be shared by a user of a terminal belonging to the group and desiring to access the same information as the information to be provided; and
transmitting the information to be provided ant the generated the picture or display to the terminal devices.

3. The information providing method according to claim 1, wherein
when receiving notice of having selected information for accessing the information to be shared from the terminal device of the user, said information management device transmits the information to be shared to a user of the terminal device.

4. The information providing method according to claim 3, wherein
charged information provided by said information providing system is specified as the information to be shared, said information management device manages data used for said information providing system to collect a price to be paid associated with a user of the terminal device selecting information to be shared.

5. The information providing method according to claim 1, wherein
said information management device authenticates a user accessing said information management device via the terminal device and specifies a group to which the user belongs, based on the result of the authentication.

6. The information providing method according to claim 1, wherein
when receiving the information for accessing the information to be shared, said information management device receives data for the sharing of the information to be shared, and
transmits the information for accessing the information to be shared to the terminal device of a user belonging to the group, based on the data for the sharing.

7. A device for enabling a user of a terminal device to access information provided by an information providing system via a communication network, comprising:
a group specification unit for enabling a person to specify users of terminal devices that the person desires to access common information, as members belonging to a group;
an information acquisition unit for obtaining at least information related to information that the user of a terminal device specifies as information to be shared by the group, among information provided by an information providing system; and
a shared information presentation unit for presenting the information to be shared by the group to which the user belongs, to the users of terminal devices, using the related information.

8. The information management device according to claim 7, further comprising
a transmission control unit for controlling so as to transmit the information to be shared to the terminal device when the user of a terminal device selects the information to be shared that is presented by said shared information presentation unit.

9. The information management device according to claim 8, wherein
said transmission control unit manages data for said information providing system to collect a price to be paid associated with the user of a terminal device selecting the charged information to be shared that is provided by said information providing system.

10. The information management device according to claim 7, further comprising
an authentication unit for authenticating a user using a terminal device to access said information management device,
wherein
said shared information presentation unit specifies a group to which the user, using a terminal device, accesses said information management device, based on the result of the authentication by said authentication unit, and presents the information to be shared that has been specified by the group.

11. The information management device according to claim 7, wherein
when a user of the terminal device specifying the information to be shared, said information acquisition unit prompts the user to input data relating to the sharing of the information to be shared, and
said shared information presentation unit presents the information to be shared based on the data input by the user having specified the information to be shared.

12. A device for enabling a user of a terminal device to access information provided by an information providing system via a communication network, comprising:
group specification means for enabling a person to specify users of terminal devices that the person desires to access common information, as members belonging to a group;
information acquisition means for obtaining at least information related to information that the user of a terminal device specifies as information to be shared by the group, among information provided by an information providing system; and
shared information presentation means for presenting the information to be shared by the group to which the user belongs, to the users of terminal devices, using the related information.

13. A computer readable portable type storage medium which is used by a computer which enables a user of a terminal device to access information provided by an information providing system via a communication network stores a program which directs the computer to execute:
a step for enabling a person to specify users of terminal devices that the person desires to allow access to common information, as members belonging to a group;
a step for obtaining at least information related to information to be shared by the group that that the user of a terminal device specifies as information to be shared by the group, among information provided by the information providing system; and
a step for presenting the information to be shared by the group to which the user belongs, to the users of terminal devices, using related information.
